(19) United States
(12) Patent Application Publication
(10) Pub. No.: US 2026/0171324 A1
(43) Pub. Date: Jun. 18, 2026

(54) CAPACITOR

(71) Applicant: Panasonic Intellectual Property Management Co., Ltd., Osaka (JP)

(72) Inventors: ERIKO KANATANI, Toyama (JP); MASANOBU SHIMA, Toyama (JP)

(21) Appl. No.: 19/373,813

(22) Filed: Oct. 30, 2025

(30) Foreign Application Priority Data
Dec. 12, 2024 (JP) 2024-218110

(51) Int. Cl. H01G 4/40; H01G 2/10; H01G 4/38

(52) U.S. Cl. CPC H01G 4/40; H01G 2/103; H01G 4/385

(57) ABSTRACT

A capacitor includes a case that houses a capacitor element, a filling resin filled in the case, and a bus bar. The filling resin includes an exposed surface exposed to the outside. The bus bar includes a protruding part protruding from the inside of the filling resin to the outside, a flat surface part, and a first external connection terminal part. The flat surface part includes a first end and a second end that is connected to the protruding part and the first external connection terminal part. The protruding part is bent at the second end around a first axis to extend in a first direction, and the first external connection terminal part is bent at the second end around a second axis to extend in a second direction opposite to the first direction. Each of the first axis and the second axis is disposed in a plane facing the exposed surface.

### BACKGROUND

### 1. Technical Field

The present disclosure relates generally to a capacitor, and more particularly to a capacitor including a capacitor element.

### 2. Description of the Related Art

Unexamined Japanese Patent Publication No. 2019-033133 discloses a capacitor. This capacitor includes a case that houses a capacitor element and a pair of positive and negative electrode plates for external connection. The capacitor element includes an electrode at each of both ends thereof. Each of the pair of positive and negative electrode plates for external connection includes an external connecting part.

The capacitor element constitutes a plurality of capacitor elements disposed side by side while the capacitor elements each include the electrode parts facing outward. The capacitor elements are connected to an electrode plate for external connection using an element electrode plate for connecting these capacitor elements in common.

The pair of positive and negative electrode plates for external connection includes main bodies that are stacked on each other in an up-down direction above the capacitor elements while being connected to the element electrode plate, and the main bodies each include an external connecting part that extends from an outer edge of corresponding one of the main bodies.

### SUMMARY

A capacitor according to an aspect of the present disclosure includes a capacitor element, a case that houses the capacitor element, a filling resin filled in the case to seal the capacitor element, the filling resin including an exposed surface exposed to the outside, and a bus bar connected to the capacitor element, the bus bar extending from the exposed surface of the filling resin to the outside. The bus bar includes a protruding part, a flat surface part, and a first external connection terminal part, the protruding part protruding from an inside of the filling resin to the outside. The flat surface part includes a first end and a second end, the second end being opposite to the first end and being connected to the protruding part and the first external connection terminal part. The protruding part is bent at the second end around a first axis of the flat surface part to extend in a first direction, and the first external connection terminal part is bent at the second end around a second axis of the flat surface part to extend in a second direction opposite to the first direction. Each of the first axis and the second axis is disposed in a plane facing the exposed surface.

The present disclosure enables alleviating stress generated in a bus bar during attachment work to an external device, for example.

### BRIEF DESCRIPTION OF THE DRAWINGS

FIG. 1 is a perspective view illustrating a capacitor according to a first exemplary embodiment;

FIG. 2 is an exploded perspective view illustrating the capacitor according to the first exemplary embodiment;

FIG. 3 is a sectional view illustrating the capacitor according to the first exemplary embodiment;

FIG. 4 is a front view illustrating bus bars used in the capacitor according to the first exemplary embodiment;

FIG. 5 is a plan view illustrating the bus bars according to the first exemplary embodiment;

FIG. 6 is an enlarged plan view of part A in FIG. 5;

FIG. 7 is a side view illustrating the bus bars according to the first exemplary embodiment;

FIG. 8 is a perspective view illustrating a capacitor according to a second exemplary embodiment;

FIG. 9 is an exploded perspective view illustrating the capacitor according to the second exemplary embodiment;

FIG. 10 is a sectional view illustrating the capacitor according to the second exemplary embodiment;

FIG. 11 is a front view illustrating bus bars used in the capacitor according to the second exemplary embodiment;

FIG. 12 is a plan view illustrating the bus bars according to the second exemplary embodiment;

FIG. 13 is a side view illustrating the bus bars according to the second exemplary embodiment;

FIG. 14 is a perspective view illustrating a capacitor according to a modification of the first exemplary embodiment; and

FIG. 15 is a perspective view illustrating a capacitor according to a modification of the second exemplary embodiment.

### DETAILED DESCRIPTIONS OF EMBODIMENTS

The problems with the conventional technology are briefly explained below.

The capacitor of Unexamined Japanese Patent Publication No. 2019-033133 includes the external connecting part that merely protrudes upward from a surface of resin filled in the case. Thus, when external force acts on the external connecting part when the capacitor is attached to an external device, for example, stress is likely to concentrate near a root of the external connecting part. Then, a crack is generated between the external connecting part and the resin, and sealing properties of the capacitor element may be adversely affected when the crack deepens. When the stress further increases, the external connecting part may be broken or damaged.

The present disclosure provides a capacitor capable of alleviating stress generated in a bus bar during attachment work to an external device, for example.

### 1. Overview

As described above, the capacitor of Unexamined Japanese Patent Publication No. 2019-033133 has a problem that stress is likely to concentrate near the root of the external connecting part during attachment work to an external device. This problem may cause a crack to be generated between the external connecting part and the resin to eventually affect the sealing properties of the capacitor element.

Thus, the present inventors have intensively studied to fundamentally solve the above problems to result in developing capacitor 1 as described below.

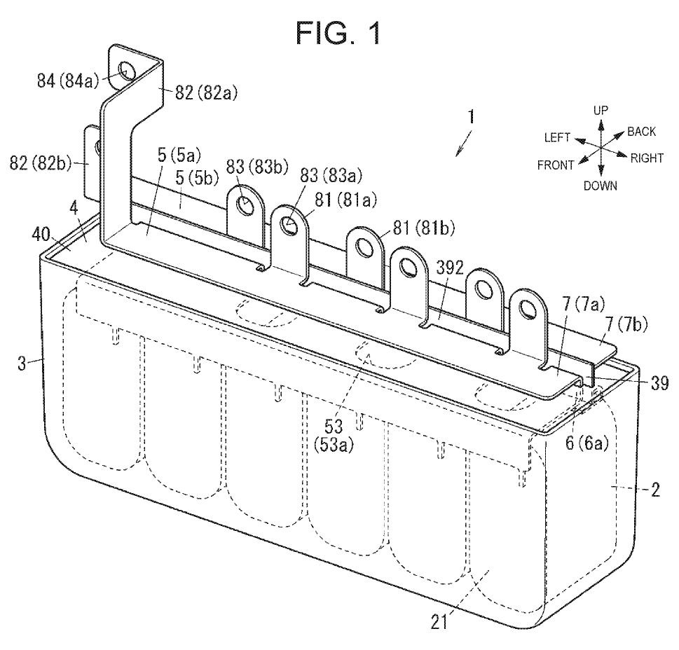

That is, capacitor 1 according to the present exemplary embodiment includes capacitor element 2, case 3 that houses capacitor element 2, filling resin 4 filled in case 3 to seal capacitor element 2, which includes exposed surface 40 exposed to the outside, and bus bars 5 that are each connected to capacitor element 2 and that extend from exposed surface 40 of filling resin 4 to the outside as illustrated in FIG. 1.

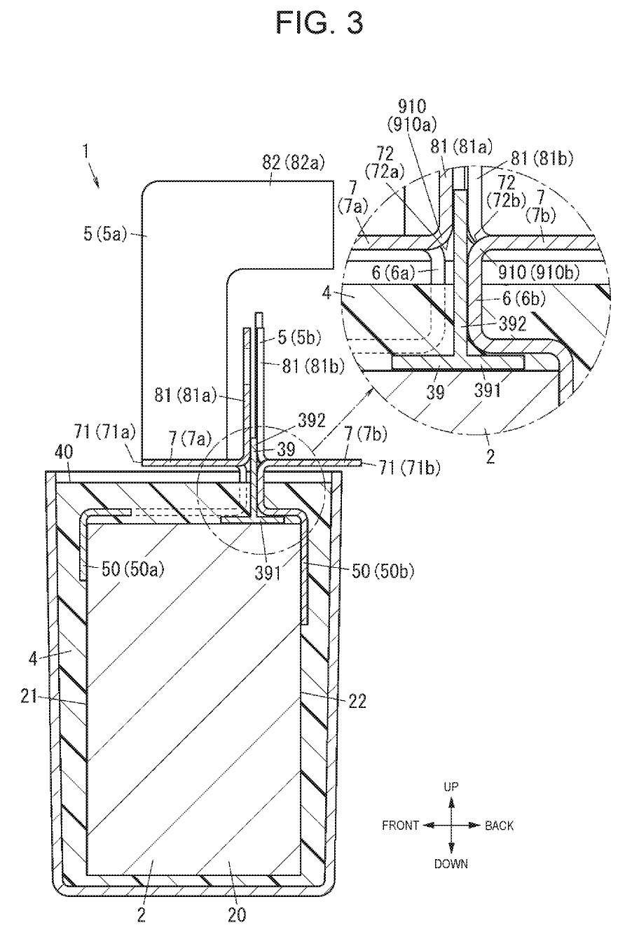

As illustrated in FIG. 3, bus bars 5 each include protruding part 6 protruding from the inside of filling resin 4 to the outside, flat surface part 7, and at least one first external connection terminal part 81.

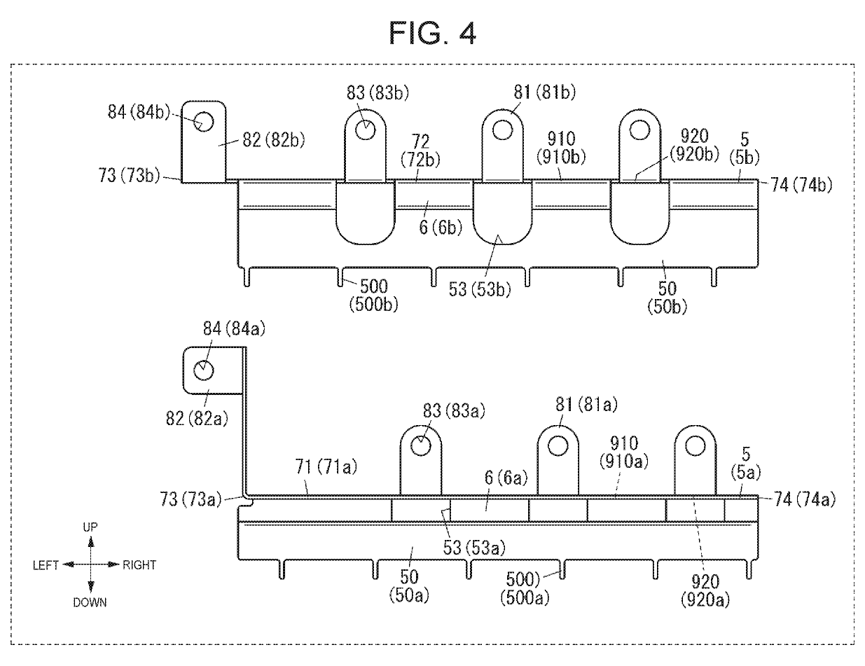

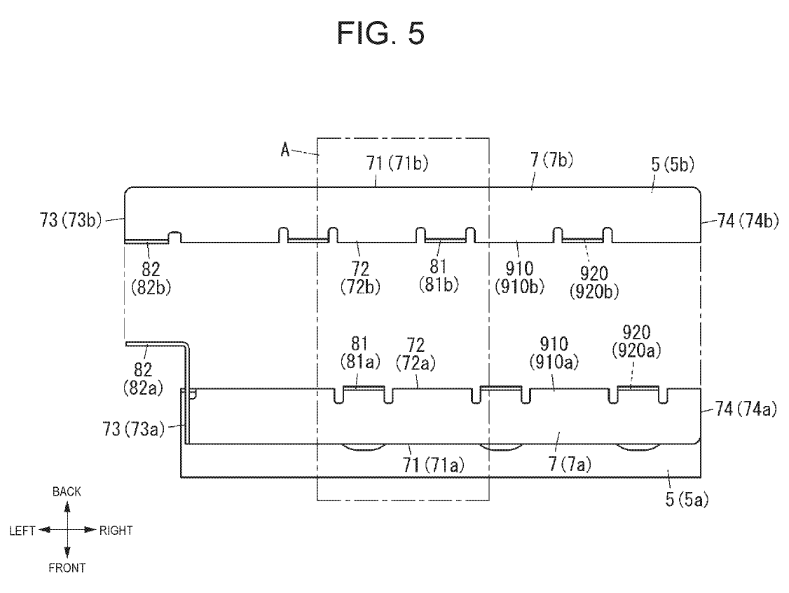

As illustrated in FIGS. 4 and 5, flat surface part 7 includes first end 71 and second end 72 being opposite to first end 71. Second end 72 is connected to protruding part 6 and first external connection terminal part 81.

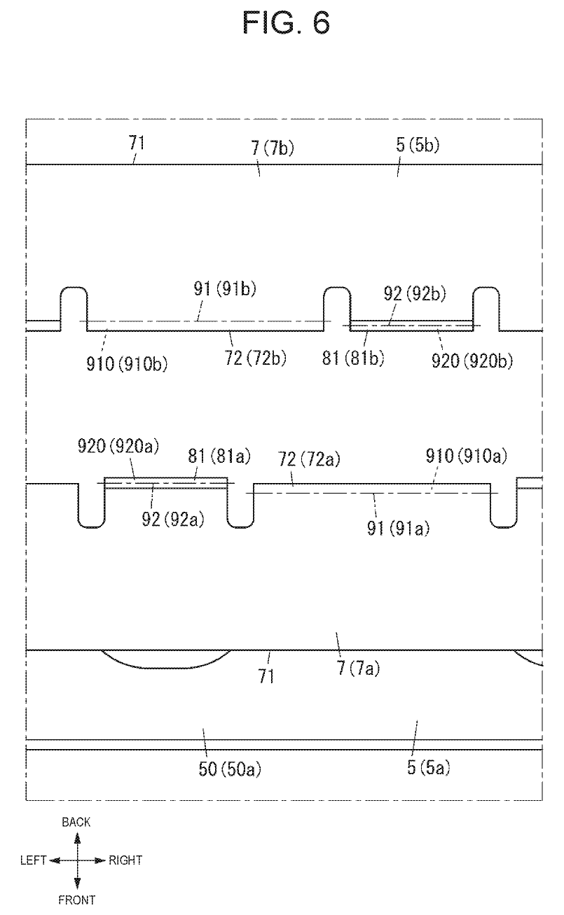

As illustrated in FIGS. 5 and 6, protruding part 6 is bent at second end 72 around first axis 91 of flat surface part 7 to extend in one direction (first direction), and first external connection terminal part 81 is bent at second end 72 around second axis 92 of flat surface part 7 to extend in a direction (second direction) opposite to the one direction (first direction). Each of first axis 91 and second axis 92 is disposed in a plane facing exposed surface 40.

When capacitor 1 described above is attached to an external device, first external connection terminal part 81 is used. In this case, external force can act on first external connection terminal part 81. Here, bus bar 5 is bent at two places between first external connection terminal part 81 and protruding part 6. That is, bus bar 5 is bent once (at one location) around first axis 91, and further bent once (at another location) around second axis 92. Stress applied to bus bar 5 is estimated to be dispersed at the two bent places and flat surface part 7.

Thus, capacitor 1 according to the present exemplary embodiment enables alleviating stress generated in bus bar 5 during attachment work to an external device, for example.

Although bus bar 5 may further include second external connection terminal part 82 as described later, a principal objective of the present exemplary embodiment is relaxation of stress generated in bus bar 5 when first external connection terminal part 81 is used, as described above.

### 2. Details

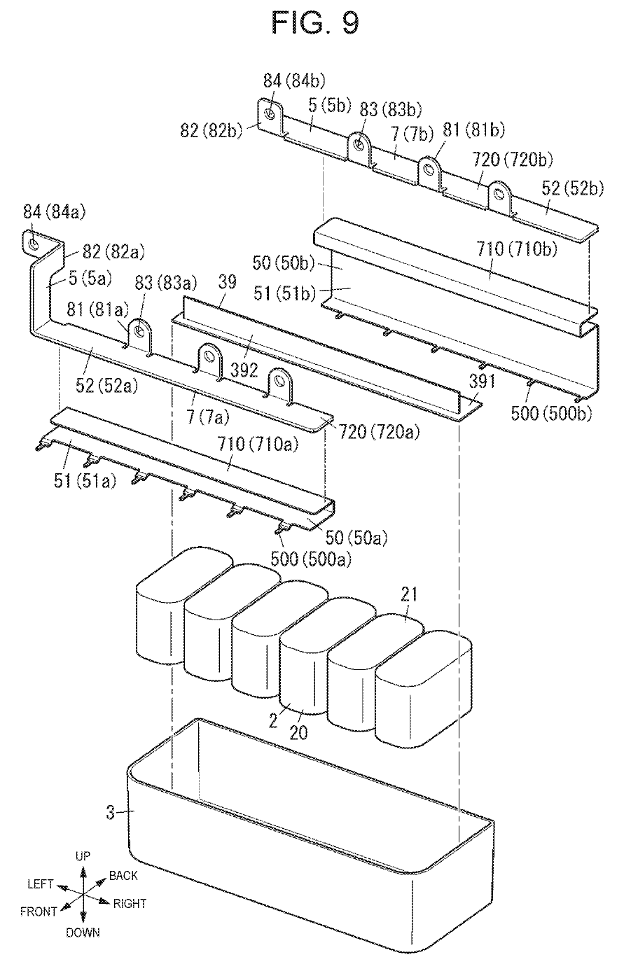

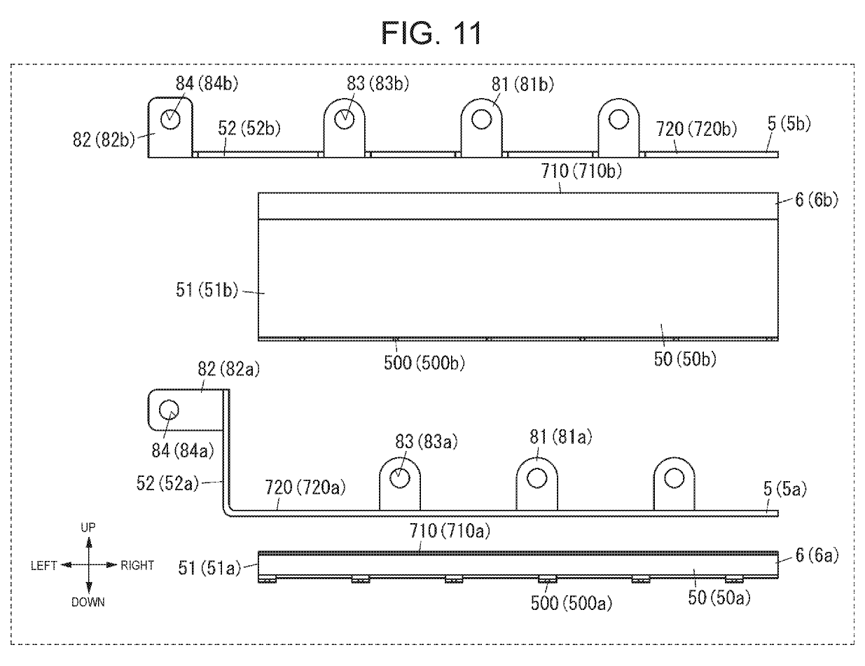

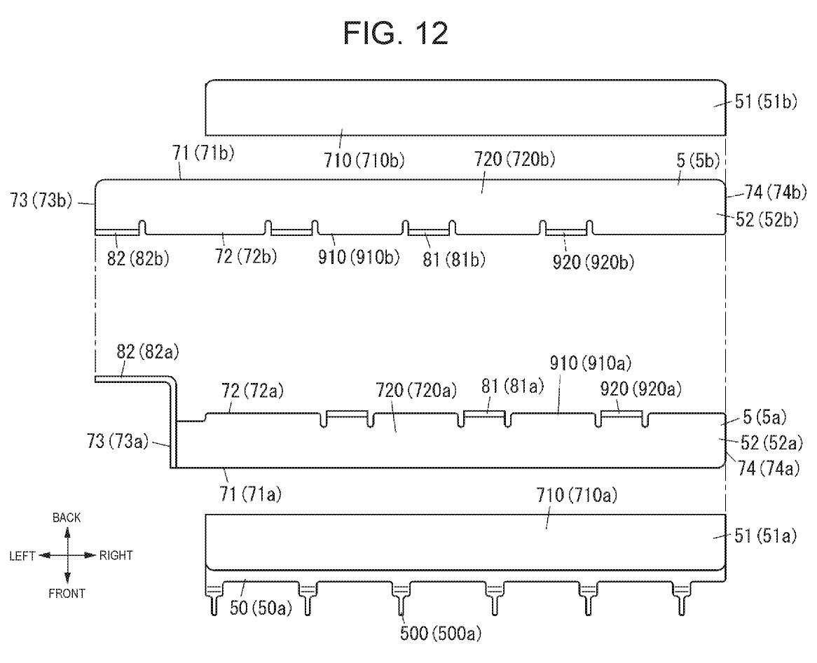

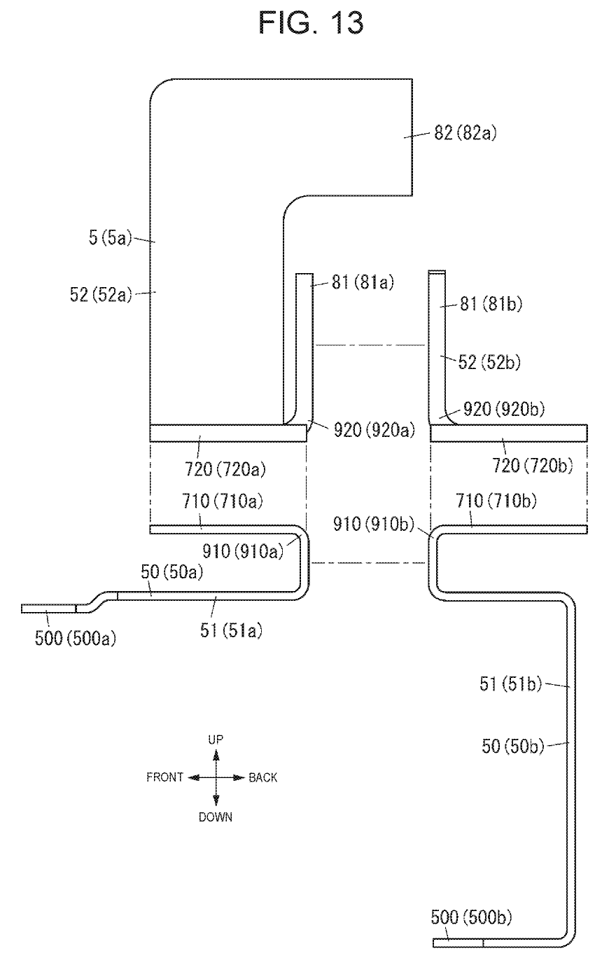

Next, capacitor 1 according to first to second exemplary embodiments is described with reference to FIGS. 1 to 15. Each drawing is a schematic view, and a ratio of a size and a thickness of each component in each drawing does not necessarily reflect an actual dimensional ratio.

Arrows indicating an up-down direction, a left-right direction, and a front-back direction in each drawing are not intended to define directions of capacitor 1 in use, but are merely written for easy understanding of description, and thus are not substantial. Viewing in the up-down direction is referred to as “plan view”, viewing in the left-right direction is referred to as “side view”, and viewing in the front-back direction is referred to as “front view”.

### (1) First Exemplary Embodiment

Hereinafter, capacitor 1 according to the first exemplary embodiment will be described with reference to FIGS. 1 to 7. As illustrated in FIG. 1, capacitor 1 includes at least one capacitor element 2, case 3, filling resin 4, and at least one bus bar 5. In the first exemplary embodiment, capacitor 1 includes six capacitor elements 2 and two bus bars 5, but capacitor element 2 and bus bar 5 are not particularly limited in number. Capacitor 1 may further include insulating member 39.

### Capacitor Element

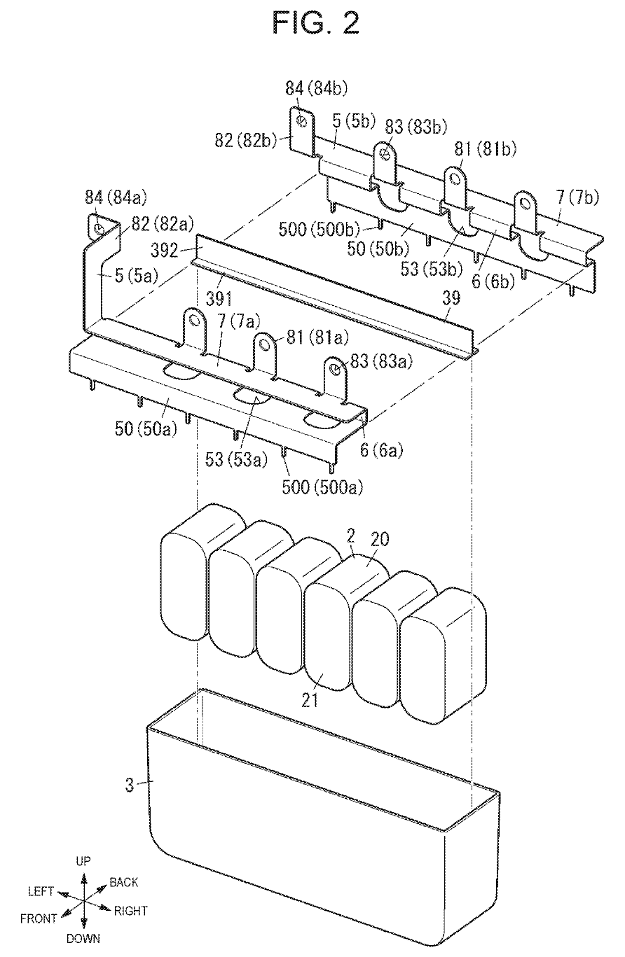

Capacitor element 2 is not particularly limited, and examples thereof include a wound film capacitor element and a laminated film capacitor element. Capacitor element 2 includes element body 20, first end-face electrode 21, and second end-face electrode 22 (see FIGS. 2 and 3).

### Element Body

Although element body 20 is not particularly limited in shape, element body 20 has a rectangular shape in plan view, a rectangular shape in side view, and an oblong shape in front view in the first exemplary embodiment. Although not illustrated, element body 20 includes a dielectric film, a first metal film, and a second metal film.

Although the dielectric film is not particularly limited in material, examples of the material include polypropylene (PP) and polyethylene terephthalate (PET).

The first metal film and the second metal film face each other with the dielectric film interposed therebetween inside element body 20. The first metal film and the second metal film are provided on the dielectric film. The first metal film and the second metal film are formed by vapor deposition, for example. Although the first metal film and the second metal film are not particularly limited in material, examples of the material include aluminum (Al), magnesium (Mg), and an alloy thereof.

### First End-face Electrode and Second End-face Electrode

First end-face electrode 21 is provided on a front surface of element body 20. Second end-face electrode 22 is provided on a rear surface of element body 20. First end-face electrode 21 and second end-face electrode 22 are each formed by metal spraying (metallikon), for example. The metal to be sprayed is not particularly limited, and examples of the metal include zinc (Zn), tin (Sn), and an alloy thereof.

First end-face electrode 21 is electrically connected to the first metal film inside element body 20. Meanwhile, second end-face electrode 22 is electrically connected to the second metal film inside element body 20.

### Arrangement Form

In the first exemplary embodiment, six capacitor elements 2 are disposed side by side in the left-right direction. Six capacitor elements 2 are disposed horizontally. That is, each of six capacitor elements 2 is disposed with first end-face electrode 21 and second end-face electrode 22 that are aligned in the front-back direction.

### Case

Case 3 houses capacitor element 2. Case 3 opens upward (see FIG. 2). Although case 3 is not particularly limited in material, and examples the material include polyphenylene sulfide (PPS), polybutylene terephthalate (PBT), and an epoxy resin (EP).

### Filling Resin

Case 3 is filled with filling resin 4 (see FIGS. 1 and 3). Filling resin 4 is obtained by curing a liquid curable resin, and has electrical insulation properties. The curable resin is not particularly limited, and examples thereof include a thermosetting resin and a photocurable resin. Specifically, the curable resin is not particularly limited, and examples thereof include an epoxy resin.

Filling resin 4 seals capacitor element 2. Consequently, capacitor element 2 is protected from humidity, dust, and the like by blocking contact with outside air. Filling resin 4 also seals a part of bus bar 5.

Filling resin 4 includes exposed surface 40. Exposed surface 40 is exposed to the outside. In the first exemplary embodiment, exposed surface 40 is an upper surface of filling resin 4 and is flat.

### Bus Bar

Bus bar 5 is a conductive member used to electrically connect capacitor element 2 to an external device (not illustrated, and the same applies hereinafter). Bus bar 5 is formed by cutting out a metal plate into a predetermined shape and appropriately bending the metal plate. The metal plate is not particularly limited, and examples thereof include a copper plate and an aluminum plate. The external device is not particularly limited, and examples thereof include components constituting an inverter, and a DC power supply (battery).

In the first exemplary embodiment, bus bar 5 includes first bus bar 5a and second bus bar 5b. First bus bar 5a is connected to first end-face electrode 21 of capacitor element 2. Meanwhile, second bus bar 5b is connected to second end-face electrode 22 of capacitor element 2. Consequently, bus bar 5 is connected to capacitor element 2.

Hereinafter, first bus bar 5a and second bus bar 5b will be collectively described as bus bar 5. When first bus bar 5a and second bus bar 5b need to be distinguished, components of first bus bar 5a are represented by adding “a” to reference numerals of components of bus bar 5, and components of second bus bar 5b are represented by adding “b” to the reference numerals of the components of bus bar 5.

Bus bar 5 extends to the outside from exposed surface 40 of filling resin 4 (see FIG. 3). In other words, a part of bus bar 5 is sealed with filling resin 4. Specifically, a part of each of first bus bar 5a and second bus bar 5b is sealed with filling resin 4. The rest of each of first bus bar 5a and second bus bar 5b exists outside filling resin 4.

Bus bar 5 includes protruding part 6, flat surface part 7, at least one first external connection terminal part 81, and element connecting part 50. In the first exemplary embodiment, bus bar 5 further includes second external connection terminal part 82. Specifically, first bus bar 5a includes protruding part 6a, flat surface part 7a, three first external connection terminal parts 81a, element connecting part 50a, and second external connection terminal part 82a. Meanwhile, second bus bar 5b includes protruding part 6b, flat surface part 7b, three first external connection terminal parts 81b, element connecting part 50b, and second external connection terminal part 82b. First external connection terminal part 81 provided in bus bar 5 is not particularly limited in number.

### Protruding Part

Protruding part 6 protrudes from the inside to the outside of filling resin 4 (see FIG. 3). In the first exemplary embodiment, protruding part 6 extends in the up-down direction. Protruding part 6a and protruding part 6b face each other with insulating member 39 interposed therebetween.

### Flat Surface Part

Flat surface part 7 has a plate shape. In the first exemplary embodiment, flat surface part 7 has a thickness in the up-down direction and a width in the front-back direction, and extends in the left-right direction by a length longer than the width (see FIG. 2).

Flat surface part 7 and exposed surface 40 of filling resin 4 face each other (see FIG. 3). In the first exemplary embodiment, the whole of flat surface part 7a faces exposed surface 40. Meanwhile, a part of flat surface part 7b does not face exposed surface 40, but the rest of flat surface part 7b faces exposed surface 40. As described above, a part of flat surface part 7 may protrude from case 3.

Flat surface part 7 is separated from filling resin 4 (see FIG. 3). That is, flat surface part 7 is not in direct contact with exposed surface 40. In the first exemplary embodiment, flat surface part 7 is not in direct contact with case 3 either.

In the first exemplary embodiment, flat surface part 7 is parallel to exposed surface 40 of filling resin 4. Alternatively, flat surface part 7 may be inclined with respect to exposed surface 40 of filling resin 4 as long as the effect of the present disclosure is not impaired.

As illustrated in FIG. 5, flat surface part 7 has a substantially rectangular shape in plan view. Flat surface part 7 includes first end 71, second end 72, third end 73, and fourth end 74. Flat surface part 7 is surrounded by first end 71, second end 72, third end 73, and fourth end 74 in plan view.

### First End

As illustrated in FIG. 5, first end 71a is an end part located forward in flat surface part 7a. Meanwhile, first end 71b is an end part located backward in flat surface part 7b.

### Second End

As illustrated in FIG. 5, second end 72a is an end part located backward in flat surface part 7a. Meanwhile, second end 72b is an end part located forward in flat surface part 7b. As described above, second end 72 is opposite to first end 71 in flat surface part 7. As illustrated in FIG. 3, second end 72a of flat surface part 7a and second end 72b of flat surface part 7b face each other with insulating member 39 interposed therebetween.

As illustrated in FIGS. 4 and 5, protruding part 6 and first external connection terminal part 81 are connected to second end 72. Protruding part 6 and first external connection terminal part 81 are not directly connected, but indirectly connected through second end 72 of flat surface part 7.

Specifically, protruding part 6a and first external connection terminal part 81a are connected to second end 72a. Protruding part 6a and first external connection terminal part 81a are indirectly connected through second end 72a of flat surface part 7a. Meanwhile, protruding part 6b and first external connection terminal part 81b are connected to second end 72b. Protruding part 6b and first external connection terminal part 81b are indirectly connected through second end 72b of flat surface part 7b.

FIG. 6 is an enlarged plan view of part A (a part surrounded by an alternate long and short dashed line) in FIG. 5. As illustrated in FIG. 6, second end 72 includes at least one first axis 91 and at least one second axis 92. First axis 91 and second axis 92 are each a virtual axis (indicated by an imaginary line of a two-dot chain line in FIG. 6), and bus bar 5 is bent around these axes. In the first exemplary embodiment, each of first axis 91 and second axis 92 extends in the left-right direction. That is, first axis 91 and second axis 92 are parallel to each other. Alternatively, first axis 91 and second axis 92 may not be parallel as long as the effects of the present disclosure are not impaired.

Each of first axis 91 and second axis 92 is disposed at a plane facing exposed surface 40. In plan view, first axis 91 and second axis 92 overlap exposed surface 40. First axis 91 and second axis 92 are illustrated only in FIG. 6 in consideration of visibility of the drawings.

In the first exemplary embodiment, second end 72a includes four first axes 91a and three second axes 92a. Meanwhile, second end 72b includes four first axes 91b and three second axes 92b.

In the first exemplary embodiment, first axis 91 and second axis 92 are alternately disposed side by side in the left-right direction. First axis 91 and second axis 92 may exist on the same straight line or may not exist on the same straight line. For example, first axis 91 and second axis 92 may be displaced in the front-back direction.

Specifically, first axis 91a and second axis 92a are alternately disposed side by side in the left-right direction and exist on substantially the same straight line as illustrated in FIGS. 5 and 6. First axis 91b and second axis 92b are alternately disposed side by side in the left-right direction and exist on substantially the same straight line. Second axis 92a faces first axis 91b. Second axis 92b faces first axis 91a. First axis 91a and first axis 91b may face each other or may not face each other.

As illustrated in FIGS. 4 to 7, protruding part 6 is bent at second end 72 around first axis 91 of flat surface part 7 to extend in one direction (first direction). As described above, a part bent around first axis 91 serves as first bent part 910. That is, first bent part 910 is a corner defined by flat surface part 7 and protruding part 6. First bent part 910 may be rounded.

Specifically, protruding part 6a is bent downward at second end 72a of flat surface part 7a around first axis 91a to form first bent part 910a. Meanwhile, protruding part 6b is bent downward at second end 72b of flat surface part 7b around first axis 91b to form first bent part 910b.

As illustrated in FIGS. 4 to 7, first external connection terminal part 81 is further bent at second end 72 around second axis 92 of flat surface part 7 to extend in a direction (second direction) opposite to the one direction. As described above, a part bent around second axis 92 serves as second bent part 920. That is, second bent part 920 is a corner defined by flat surface part 7 and first external connection terminal part 81. Second bent part 920 may be rounded.

Specifically, first external connection terminal part 81a is bent upward at second end 72a of flat surface part 7a around second axis 92a to form second bent part 920a. Meanwhile, first external connection terminal part 81b is bent upward at second end 72b of flat surface part 7b around second axis 92b to form second bent part 920b.

As described above, first axis 91 and second axis 92 are alternately disposed side by side in the left-right direction, so that first bent part 910 and second bent part 920 are alternately disposed side by side in the left-right direction. Second axis 92a faces first axis 91b, so that second bent part 920a faces first bent part 910b. Second axis 92b faces first axis 91a, so that second bent part 920b faces first bent part 910a.

First bent part 910 and second bent part 920 exist outside filling resin 4. Specifically, first bent part 910a and second bent part 920a are located above exposed surface 40. Similarly, first bent part 910b and second bent part 920b are located above exposed surface 40.

### Third End and Fourth End

As illustrated in FIG. 5, third end 73 is an end part located leftward in flat surface part 7. That is, third end 73a is located at a left end of flat surface part 7a. Meanwhile, third end 73b is located at a left end of flat surface part 7b.

Meanwhile, fourth end 74 is an end part located rightward in flat surface part 7. That is, fourth end 74a is located at a right end of flat surface part 7a. Meanwhile, fourth end 74b is located at a right end of flat surface part 7b.

### First External Connection Terminal Part

First external connection terminal part 81 is connected to an external device by fastening or the like. First external connection terminal part 81 extends in a direction parallel to a direction in which protruding part 6 extends. In the first exemplary embodiment, first external connection terminal part 81 extends in the up-down direction. Thus, first external connection terminal part 81 and protruding part 6 are parallel to each other. Alternatively, first external connection terminal part 81 and protruding part 6 may not be parallel to each other as long as the effects of the present disclosure are not impaired.

In the first exemplary embodiment, first external connection terminal part 81 and protruding part 6 may exist on the same plane extending in the up-down direction and the left-right direction. Alternatively, first external connection terminal part 81 and protruding part 6 may not exist on the same plane as long as the effects of the present disclosure are not impaired.

In the first exemplary embodiment, first external connection terminal part 81 further includes through-hole 83. Through-hole 83 is used for connection to an external device. Through-hole 83 penetrates in the front-back direction.

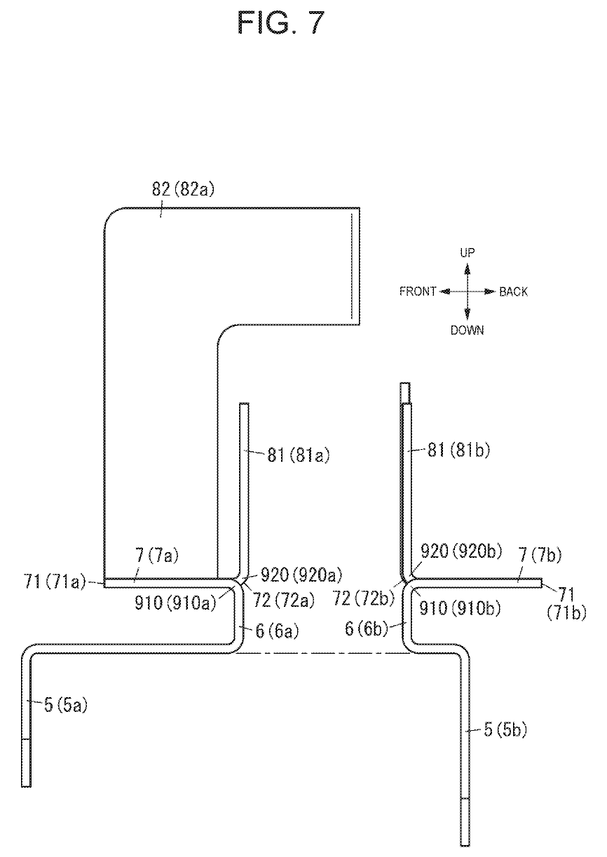

As illustrated in FIGS. 3 and 7, focusing on protruding part 6, flat surface part 7, and first external connection terminal part 81 of bus bar 5, they form a substantially T shape in side view. In other words, protruding part 6 and first external connection terminal part 81 are respectively folded back in directions opposite to each other from one end (second end 72) of flat surface part 7.

In other words, bending around first axis 91 and bending around second axis 92 are each performed in the same rotating direction. Specifically, flat surface part 7a is bent counterclockwise around first axis 91a with respect to protruding part 6a in side view (when viewed from the right). Then, first external connection terminal part 81a is bent counterclockwise around second axis 92a with reference to flat surface part 7a. As described above, the bending around first axis 91 and the bending around second axis 92 are each performed in the same rotating direction.

In other words, the surface of bus bar 5 is inverted in protruding part 6 and first external connection terminal part 81. Specifically, surfaces of first bus bar 5a mean an upper surface and a lower surface of flat surface part 7a, for example. The upper surface of flat surface part 7a is connected to a rear surface of protruding part 6a. Meanwhile, the lower surface of flat surface part 7a is connected to a rear surface of first external connection terminal part 81a. Then, the rear surface of first external connection terminal part 81a (the surface connected to the lower surface of flat surface part 7a) is located above the rear surface of protruding part 6a (the surface connected to the upper surface of flat surface part 7a). Thus, the surface of bus bar 5 is inverted in protruding part 6 and first external connection terminal part 81.

As illustrated in FIGS. 4 to 6, first bent part 910 and second bent part 920 are alternately disposed side by side in the left-right direction in front view and plan view, so that protruding part 6 and first external connection terminal part 81 are alternately disposed side by side in the left-right direction. Then, first external connection terminal part 81a and first external connection terminal part 81b are alternately disposed side by side in the left-right direction.

In the first exemplary embodiment, first external connection terminal part 81 is formed by cutting and raising, so that through-hole 53 (cut-and-raised hole) is formed accordingly as illustrated in FIG. 2. Through-hole 53 extends from immediately below first external connection terminal part 81 to element connecting part 50 through between two protruding parts 6 adjacent to each other in the left-right direction.

Bus bar 5 according to the first exemplary embodiment includes through-holes 53 as many as first external connection terminal parts 81. As described above, through-hole 53 is formed by cutting and raising, so that through-hole 53 is substantially equal in area to first external connection terminal part 81. As illustrated in FIGS. 2 and 4, through-hole 53 is adjacent to first external connection terminal part 81, protruding part 6, and element connecting part 50. Most of through-hole 53 is buried in filling resin 4.

### Element Connecting Part

Element connecting part 50 is connected to capacitor element 2. Element connecting part 50 extends forward or backward from a lower end of protruding part 6, and further extends downward. Element connecting part 50 is provided at its leading end with electrode pins 500 at least as many as capacitor elements 2.

Specifically, element connecting part 50a extends forward from a lower end of protruding part 6a and further extends downward. Element connecting part 50a is provided at the leading end with six electrode pins 500a. Electrode pin 500a is connected to first end-face electrode 21 by soldering, for example. Meanwhile, element connecting part 50b extends backward from a lower end of protruding part 6b and further extends downward. Element connecting part 50b is provided at its leading end with six electrode pins 500b. Electrode pin 500b is connected to second end-face electrode 22 by soldering, for example.

### Second External Connection Terminal Part

Second external connection terminal part 82 is connected to a DC power supply by fastening or the like. Second external connection terminal part 82 is connected to flat surface part 7 (see FIG. 2). Specifically, second external connection terminal part 82a extends upward from third end 73 of flat surface part 7a, then extends rearward, and is further bent leftward as illustrated in FIGS. 4 and 5. Second external connection terminal part 82a has a longer overall length than first external connection terminal part 81. Meanwhile, second external connection terminal part 82b extends upward from first end 71 close to third end 73 of flat surface part 7a.

In the first exemplary embodiment, second external connection terminal part 82 includes through-hole 84. Through-hole 84 is used for connection of a DC power supply. Through-hole 84 penetrates in the front-back direction.

### Insulating Member

Insulating member 39 prevents a short circuit between first bus bar 5a and second bus bar 5b. Insulating member 39 includes bottom plate part 391 and partition wall part 392 (see FIG. 2). Bottom plate part 391 has a thickness in the up-down direction and a width in the front-back direction, and extends in the left-right direction by a length longer than the width. Partition wall part 392 has a thickness in the front-back direction and a height in the up-down direction, and extends in the left-right direction by a length substantially equal to a length of bottom plate part 391. Partition wall part 392 rises upward from an almost center of bottom plate part 391 in a width direction. As described above, insulating member 39 has a substantially T-shape in side view and extends in the left-right direction (see FIGS. 2 and 3).

As illustrated in FIG. 3, a corner defined by protruding part 6a and element connecting part 50a is disposed at a front corner defined by bottom plate part 391 and partition wall part 392. Meanwhile, a corner defined by protruding part 6b and element connecting part 50b is disposed at a rear corner defined by bottom plate part 391 and partition wall part 392.

Although insulating member 39 is not particularly limited in material, and examples the material include polyphenylene sulfide (PPS), polybutylene terephthalate (PBT), and an epoxy resin (EP).

### Effect

When capacitor 1 according to the first exemplary embodiment is attached to an external device, first external connection terminal part 81 is used. In this case, external force can act on first external connection terminal part 81 mainly in the front-back direction. Here, bus bar 5 is bent at two places between first external connection terminal part 81 and protruding part 6. That is, first axis 91 and second axis 92 extend in a direction (left-right direction) substantially perpendicular to a direction in which the external force acts, and bus bar 5 is bent once (at one place) around first axis 91, and are further bent once (at another one place) around second axis 92. It is presumed that stress applied to bus bar 5 is dispersed at the two bent places and flat surface part 7.

Thus, capacitor 1 according to the first exemplary embodiment enables alleviating stress generated in bus bar 5 during attachment work to an external device, for example. Consequently, a crack is less likely to occur between protruding part 6 and filling resin 4. Increase in stress is also suppressed, so that bus bar 5 is also prevented from being broken or damaged.

In particular, when first axis 91 and second axis 92 are arranged closer to be parallel to each other, dispersion of stress generated in bus bar 5 is facilitated. Consequently, the stress generated in bus bar 5 is likely to be alleviated.

In the first exemplary embodiment, first bent part 910 and second bent part 920 exist outside filling resin 4. As described above, first bent part 910 and second bent part 920 are not fixed with filling resin 4, so that stress generated in bus bar 5 is likely to be dispersed. That is, first bent part 910 and second bent part 920 can be elastically deformed, so that the stress generated in bus bar 5 is likely to be dispersed.

Additionally, flat surface part 7 and exposed surface 40 of filling resin 4 face each other. Thus, space can be saved as compared with when flat surface part 7 and exposed surface 40 of filling resin 4 do not face each other at all.

Flat surface part 7 is located away from filling resin 4. As described above, flat surface part 7 is not in direct contact with filling resin 4, so that stress generated in bus bar 5 is likely to be dispersed. That is, a new stress is less likely to be generated inside flat surface part 7 even when first bent part 910 and second bent part 920 are elastically deformed to slightly incline flat surface part 7, for example.

Additionally, protruding part 6 extends in a direction parallel to a direction in which first external connection terminal part 81 extends (the up-down direction in the first exemplary embodiment). Thus, the stress generated in bus bar 5 is likely to be dispersed.

In the first exemplary embodiment, bus bar 5 includes through-hole 53. It is presumed that through-hole 53 also contribute to relaxation of stress. Then, most of through-hole 53 is buried in filling resin 4, so that adhesion between bus bar 5 and filling resin 4 can be improved by an anchor effect.

Capacitor 1 according to the first exemplary embodiment enables not only first external connection terminal part 81 to be connected to an external device (e.g., a semiconductor device), but also second external connection terminal part 82 to be connected to a DC power supply (battery). In this case, flat surface part 7 also serves as a path through which a direct current (DC current) flows in particular. Flat surface part 7 exists outside filling resin 4, so that heat generated by a current flowing through flat surface part 7 is dissipated by natural convection.

### (2) Second Exemplary Embodiment

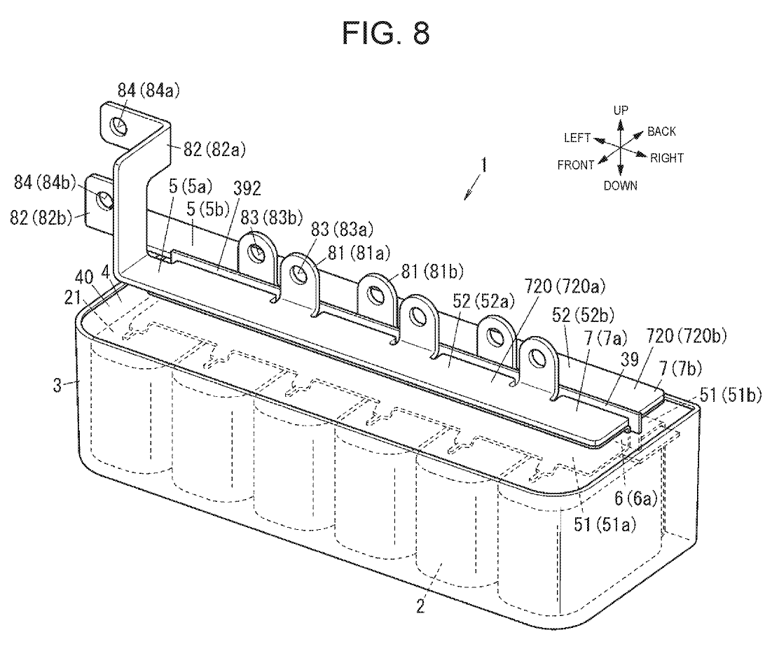

Capacitor 1 according to a second exemplary embodiment will be described with reference to FIGS. 8 to 13. In the second exemplary embodiment, similar components as in the first exemplary embodiment are denoted by the same reference numerals as those in the first exemplary embodiment, and details of the components may not be described. Hereinafter, differences from the first exemplary embodiment will be mainly described.

### Difference 1

Although each of first bus bar 5a and second bus bar 5b includes a single member in the first exemplary embodiment, each of first bus bar 5a and second bus bar 5b includes a plurality of members in the second exemplary embodiment. Alternatively, one of first bus bar 5a and second bus bar 5b may include a plurality of members, and the other of first bus bar 5a and second bus bar 5b may include a single member.

Specifically, bus bar 5 includes first member 51 and second member 52 in the second exemplary embodiment. More specifically, first bus bar 5a includes first member 51a and second member 52a. Then, second bus bar 5b includes first member 51b and second member 52b. First member 51 and second member 52 each may be made of an identical or different material.

First member 51 includes first bent part 910. Specifically, first member 51 includes protruding part 6, first flat surface part 710, and element connecting part 50. In the second exemplary embodiment, first bent part 910 is a corner defined by first flat surface part 710 and protruding part 6. First bent part 910 may be rounded. First flat surface part 710 constitutes flat surface part 7.

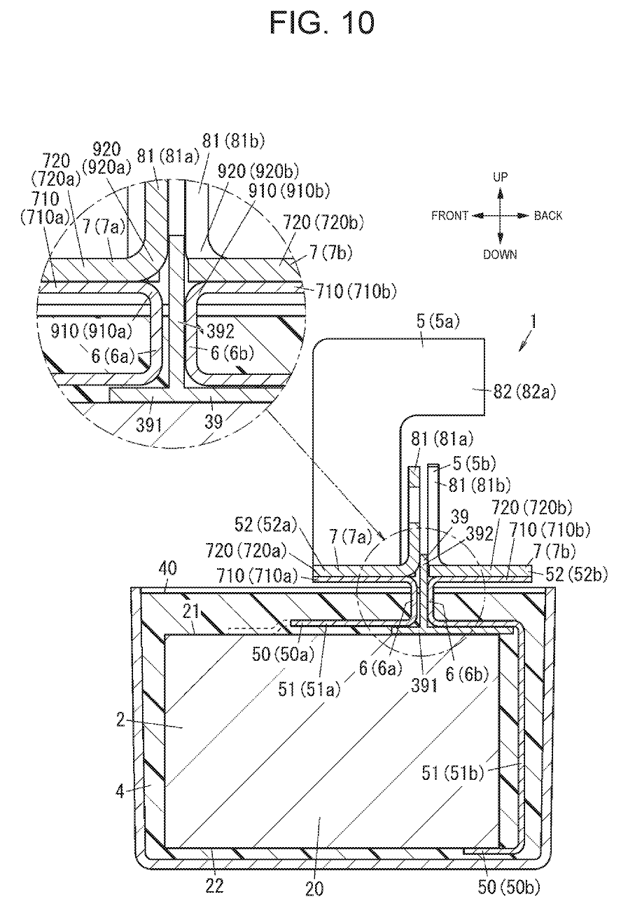

Second member 52 includes second bent part 920. Specifically, second member 52 includes second flat surface part 720, at least one first external connection terminal part 81, and second external connection terminal part 82. Second bent part 920 is a corner defined by second flat surface part 720 and first external connection terminal part 81. Second bent part 920 may be rounded. Second flat surface part 720 also constitutes flat surface part 7 similarly to first flat surface part 710. That is, flat surface part 7 includes first flat surface part 710 and second flat surface part 720. In the second exemplary embodiment, first flat surface part 710 and second flat surface part 720 are overlapped in the up-down direction (see FIG. 10).

First member 51 and second member 52 are joined to each other. Specifically, an upper surface of first flat surface part 710 and a lower surface of second flat surface part 720 are stacked on each other, and then first flat surface part 710 and second flat surface part 720 are joined to each other. That is, flat surface part 7 includes a joined part between first member 51 and second member 52 (first flat surface part 710, second flat surface part 720). A joining method is not particularly limited, and examples thereof include welding.

In the second exemplary embodiment, first member 51 and second member 52 are different in thicknesses. Specifically, second member 52 has a larger thickness than first member 51.

Here, a thickness of second member 52 means a thickness of second flat surface part 720, a thickness of first external connection terminal part 81, and a thickness of second external connection terminal part 82 when these thicknesses are equal to each other. When the thickness of second flat surface part 720, the thickness of first external connection terminal part 81, and the thickness of second external connection terminal part 82 are different from each other, the thickness of second member 52 means a minimum thickness among these thicknesses.

A thickness of first member 51 means a thickness of protruding part 6, a thickness of first flat surface part 710, and a thickness of element connecting part 50 when these thicknesses are equal to each other. When the thickness of protruding part 6, the thickness of first flat surface part 710, and the thickness of element connecting part 50 are different, the thickness of first member 51 means a maximum thickness among these thicknesses.

### Difference 2

The second exemplary embodiment is different from the first exemplary embodiment in the placement form of capacitor elements 2. Specifically, although six capacitor elements 2 are disposed while being laid in the first exemplary embodiment, six capacitor elements 2 are disposed while being erected in the second exemplary embodiment. That is, each of six capacitor elements 2 is disposed with first end-face electrode 21 and second end-face electrode 22 that are aligned in the up-down direction. Consequently, a shape of element connecting part 50 of bus bar 5, a shape of case 3, and the like in the second exemplary embodiment are also different from those of the first exemplary embodiment.

### Effect

The second exemplary embodiment also achieves effect similar to that in the first exemplary embodiment.

Additionally, bus bar 5 includes the plurality of members (first member 51 and second member 52) in the second exemplary embodiment, thus facilitating manufacture of capacitor 1. That is, first member 51 and second member 52 may be joined to each other after capacitor element 2 is sealed with filling resin 4, for example, thus facilitating manufacture of capacitor 1.

Second member 52 has a larger thickness than first member 51, so that second member 52 has lower electric resistance than first member 51. Thus, heat generation during energization can be suppressed. Additionally, second member 52 exists outside filling resin 4, so that heat of second member 52 is dissipated by natural convection. That is, second member 52 enables enhancing heat dissipation. In contrast, first member 51 has a smaller thickness than second member 52, thus facilitating processing including processing of soldering to capacitor element 2 and enabling manufacturing cost to be reduced.

### 3. Modification

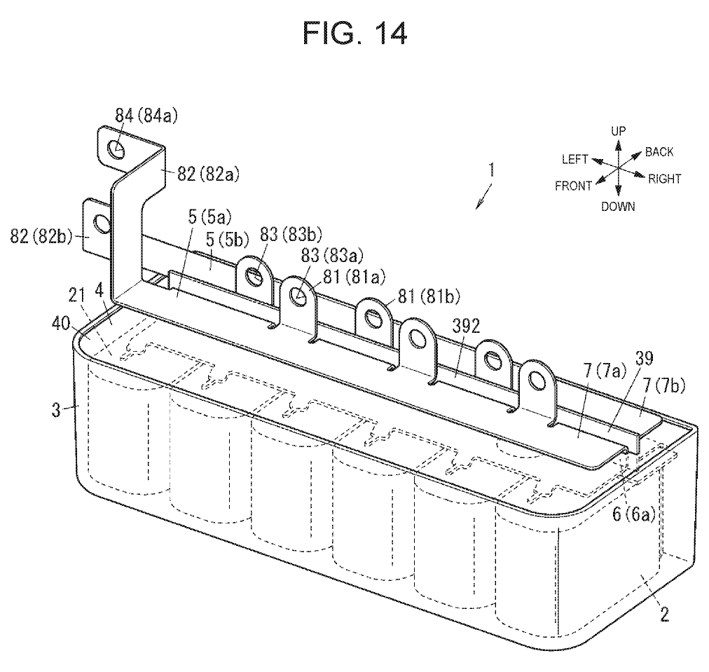

FIG. 14 illustrates a modification of capacitor 1 according to the first exemplary embodiment. Although six capacitor elements 2 are disposed while being laid in the first exemplary embodiment, six capacitor elements 2 are disposed while being erected in this modification.

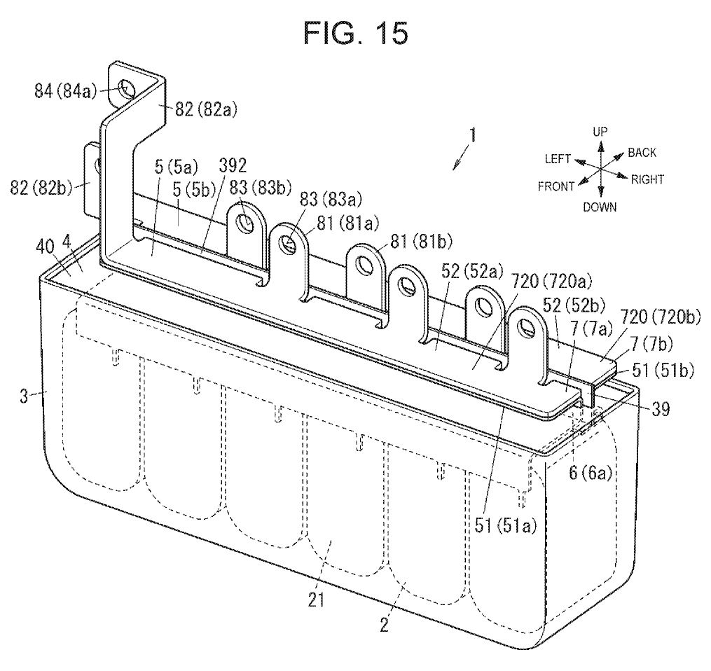

FIG. 15 illustrates a modification of capacitor 1 according to the second exemplary embodiment. Although six capacitor elements 2 are disposed while being erected in the second exemplary embodiment, six capacitor elements 2 are disposed while being laid in this modification.

Capacitor 1 according to the first and second exemplary embodiments (including the modification) may be equipped with a heat sink, a heat spreader, or the like. Consequently, heat dissipation can be further enhanced.

### 4. Aspects

As is apparent from the above exemplary embodiments and modifications, the present disclosure includes aspects below. Hereinafter, reference numerals are given in parentheses only to clarify a correspondence relationship with the exemplary embodiments.

A first aspect is capacitor (1) that includes capacitor element (2), case (3) that houses capacitor element (2), filling resin (4) filled in case (3) to seal capacitor element (2), filling resin (4) including exposed surface (40) exposed to the outside, and bus bar (5) connected to capacitor element (2), bus bar (5) extending from exposed surface (40) of filling resin (4) to the outside. Bus bar (5) includes protruding part (6), flat surface part (7), and first external connection terminal part (81), protruding part (6) protruding from the inside of filling resin (4) to the outside. Flat surface part (7) includes first end (71) and second end (72), second end (72) being opposite to first end (71) and being connected to protruding part (6) and first external connection terminal part (81). Protruding part (6) is bent at second end (72) around first axis (91) of flat surface part (7) to extend in a first direction, and first external connection terminal part (81) is bent at second end (72) around second axis (92) of flat surface part (7) to extend in a second direction opposite to the first direction. Each of first axis (91) and second axis (92) is disposed in a plane facing exposed surface (40).

This aspect enables alleviating stress generated in bus bar (5) during attachment work to an external device, for example.

A second aspect is capacitor (1) based on the first aspect. In the second aspect, first bent part (910) bent around first axis (91) and second bent part (920) bent around second axis (92) exist outside filling resin (4).

According to this aspect, first bent part (910) and second bent part (920) are not fixed with filling resin (4), so that stress generated in bus bar (5) is likely to be dispersed.

A third aspect is capacitor (1) based on the first or second aspect. In the third aspect, flat surface part (7) and exposed surface (40) of filling resin (4) face each other.

According to this aspect, space saving can be achieved as compared with when flat surface part (7) and exposed surface (40) of filling resin (4) do not face each other at all.

A fourth aspect is capacitor (1) based on any one of the first to third aspects. In the fourth aspect, flat surface part (7) is separated from filling resin (4).

According to this aspect, flat surface part (7) is not in direct contact with the filling resin (4), so that stress generated in bus bar (5) is likely to be dispersed.

A fifth aspect is capacitor (1) based on any one of the first to fourth aspects. In the fifth aspect, the first direction and the second direction are parallel to each other, protruding part (6) extending in the first direction, first external connection terminal part (81) extending in the second direction.

According to this aspect, stress generated in bus bar (5) is likely to be dispersed.

A sixth aspect is capacitor (1) based on any one of the first to fifth aspects. In the sixth aspect, bus bar (5) includes first member (51) including first bent part (910) and second member (52) including second bent part (920). First member (51) and second member (52) are joined to each other. Flat surface part (7) includes joined part (710, 720) between first member (51) and second member (52).

According to this aspect, first member (51) and second member (52) may be joined to each other after capacitor element (2) is sealed with filling resin (4), for example, thus facilitating manufacture of capacitor (1).

A seventh aspect is capacitor (1) based on any one of the first to sixth aspects. In the seventh aspect, a thickness of second member (52) is greater than a thickness of first member (51).

According to this aspect, second member (52) has lower electric resistance than first member (51), so that heat generation during energization can be suppressed.

An eighth aspect is capacitor (1) based on any one of the first to seventh aspects. In the eighth aspect, bus bar (5) further includes second external connection terminal part (82) connected to flat surface part (7).

According to this aspect, first external connection terminal part (81) can be connected to an external device (e.g., a semiconductor device), and second external connection terminal part (82) can be connected to a DC power supply (battery).

What is claimed is:

1. A capacitor comprising;
a capacitor element;
a case that houses the capacitor element;
a filling resin filled in the case to seal the capacitor element, the filling resin including an exposed surface exposed to an outside; and
a bus bar connected to the capacitor element, the bus bar extending from the exposed surface of the filling resin to the outside, wherein:
the bus bar includes a protruding part, a flat surface part, and a first external connection terminal part, the protruding part protruding from an inside of the filling resin to the outside,
the flat surface part includes a first end and a second end, the second end being opposite to the first end and being connected to the protruding part and the first external connection terminal part,
the protruding part is bent at the second end around a first axis of the flat surface part to extend in a first direction,
the first external connection terminal part is bent at the second end around a second axis of the flat surface part to extend in a second direction opposite to the first direction, and
each of the first axis and the second axis is disposed in a plane facing the exposed surface.

2. The capacitor according to claim 1, wherein a first bent part bent around the first axis and a second bent part bent around the second axis exist outside the filling resin.

3. The capacitor according to claim 1, wherein the flat surface part and the exposed surface of the filling resin face each other.

4. The capacitor according to claim 1, wherein the flat surface part is separated from the filling resin.

5. The capacitor according to claim 1, wherein the first direction and the second direction are parallel to each other, the protruding part extending in the first direction, the first external connection terminal part extending in the second direction.

6. The capacitor according to claim 2, wherein:
the bus bar includes a first member including the first bent part and a second member including the second bent part,
the first member and the second member are joined to each other, and
the flat surface part includes a joined part between the first member and the second member.

7. The capacitor according to claim 6, wherein a thickness of the second member is greater than a thickness of the first member.

8. The capacitor according to claim 1, wherein the bus bar further includes a second external connection terminal part connected to the flat surface part.
